(19) United States
(12) Patent Application Publication
(10) Pub. No.: US 2026/0023382 A1
(43) Pub. Date: Jan. 22, 2026

(54) DEVICE AND METHOD FOR CREATING DYNAMIC OCCUPANCY GRID MAP

(71) Applicant: HL Klemove Corp., Incheon (KR)

(72) Inventor: Yong Hyeon CHO, Incheon (KR)

(73) Assignee: HL Klemove Corp., Incheon (KR)

(21) Appl. No.: 18/923,067

(22) Filed: Oct. 22, 2024

(30) Foreign Application Priority Data
Jul. 16, 2024 (KR) 10-2024-0093862

(51) Int. Cl. G05D 1/246; G01S 13/89; G05D 109/10; G05D 111/30; G06F 17/17

(52) U.S. Cl. CPC G05D 1/2464; G01S 13/89; G06F 17/17; G05D 2109/10; G05D 2111/30

(57) ABSTRACT

The disclosure relates to a device and method for creating a dynamic occupancy grid map. Specifically, a dynamic occupancy grid map creation device comprises an object detector calculating a measurement based on a reception signal received from a radar sensor and detecting an object around a host vehicle, a shape estimator estimating a shape of a target vehicle when the target vehicle is detected, an occupancy probability updater ellipse-fitting the shape of the target vehicle to a point cloud and updating an occupancy probability of a grid for the target vehicle of a dynamic occupancy grid map (DOGM) based on the fitted shape, and a compensator compensating for a position of the host vehicle over time, on the dynamic occupancy grid map.

### CROSS-REFERENCE TO RELATED APPLICATION

This application claims priority from Korean Patent Application No. 10-2024-0093862, filed on Jul. 16, 2024, which is hereby incorporated by reference for all purposes as if fully set forth herein.

### BACKGROUND

### Field

The present embodiments relate to a device and method for creating a dynamic occupancy grid map.

### Description of Related Art

Recently, vehicles equipped with radar sensors are increasing. The electronic control unit of the vehicle may calculate the distance, relative velocity and angle between the vehicle and an object around the vehicle based on the information output from the radar sensor installed in the vehicle.

As such, a radar sensor-equipped vehicle may provide various safety and convenience functions using, e.g., the distance, relative velocity, and angle between the vehicle and the object around the vehicle.

For example, advanced driver assistance system (ADAS) may mean a state-of-the-art driver assistance system designed to assist a vehicle driver in driving and enhance safety.

With the above-described information from the radar sensor, ADAS may be used in, e.g., adaptive cruise control (ACC) for adjusting the velocity while keeping a distance from the preceding vehicle, lane keeping assist (LKA) for assisting lane keeping, and blind spot detection (BSD) for monitoring blind spots.

These functions require accurate radar sensor detection. Cut-ins meaning that a surrounding vehicle enters the traveling path of the host vehicle are frequent in the congested situation where there are vehicles around, and misrecognition thereof may render it difficult to provide the ADAS function.

Therefore, a need exists for a technique for detecting a cut-in of a surrounding vehicle.

### BRIEF SUMMARY

In the foregoing background, the disclosure provides a technique for detecting a cut-in vehicle to minimize misrecognition in various environments.

To address the foregoing problems, in an aspect, the disclosure provides a dynamic occupancy grid map creation device comprising an object detector calculating a measurement based on a reception signal received from a radar sensor and detecting an object around a host vehicle, a shape estimator estimating a shape of a target vehicle when the target vehicle is detected, an occupancy probability updater ellipse-fitting the shape of the target vehicle to a point cloud and updating an occupancy probability of a grid for the target vehicle of a dynamic occupancy grid map (DOGM) based on the fitted shape, and a compensator compensating for a position of the host vehicle over time, on the dynamic occupancy grid map.

In another aspect, the disclosure provides a dynamic occupancy grid map creation method comprising an object detection step calculating a measurement based on a reception signal received from a radar sensor and detecting an object around a host vehicle, a shape estimation step estimating a shape of a target vehicle when the target vehicle is detected, an occupancy probability update step ellipse-fitting the shape of the target vehicle to a point cloud and updating an occupancy probability of a grid for the target vehicle of a dynamic occupancy grid map (DOGM) based on the fitted shape, and a compensation step compensating for a position of the host vehicle over time, on the dynamic occupancy grid map.

In another aspect, the disclosure provides a vehicle control device controlling a vehicle by creating a dynamic occupancy grid map comprising at least one memory including a computer program instruction, and at least one processor executing the computer program instruction, wherein the at least one processor calculates a measurement based on a reception signal received from a radar sensor and detects an object around a host vehicle, estimates a shape of a target vehicle when the target vehicle is detected, ellipse-fits the shape of the target vehicle to a point cloud and updating an occupancy probability of a grid for the target vehicle of a dynamic occupancy grid map (DOGM) based on the fitted shape, and compensates for a position of the host vehicle over time, on the dynamic occupancy grid map.

According to the disclosure, there may be provided a technique for detecting a cut-in vehicle to minimize misrecognition in various environments.

### DESCRIPTION OF DRAWINGS

The above and other objects, features, and advantages of the disclosure will be more clearly understood from the following detailed description, taken in conjunction with the accompanying drawings, in which:

FIG. 1A is a view illustrating that a cut-in occurs as another vehicle enters from a rear right side of a host vehicle in a traveling direction according to an embodiment;

FIG. 1B is a view illustrating a result of detection of a radar sensor equipped in a host vehicle in the situation of FIG. 1A according to an embodiment;

FIG. 2 is a view illustrating creating a dynamic occupancy grid map based on the result of FIG. 1B according to an embodiment;

FIG. 3 is a block diagram schematically illustrating a dynamic occupancy grid map creation device according to an embodiment of the disclosure;

FIG. 4 is a view illustrating ellipse fitting by applying a least squares method according to an embodiment;

FIG. 5 is a view illustrating fitting a shape of a target vehicle to a track and a point cloud according to an embodiment;

FIG. 6A is a view illustrating a situation before a target vehicle cuts in a vehicle traveling path of a host vehicle, on a dynamic occupancy grid map according to an embodiment;

FIG. 6B is a view illustrating a situation when a target vehicle cuts in a vehicle traveling path of a host vehicle, on a dynamic occupancy grid map according to an embodiment;

FIG. 7A is a view illustrating a time when a target vehicle cuts in a vehicle traveling path of a host vehicle, on a dynamic occupancy grid map according to an embodiment;

FIG. 7B is a view illustrating a time when a point cloud is detected in a vehicle traveling path of a host vehicle on a dynamic occupancy grid map according to an embodiment;

FIG. 8 is a flowchart illustrating a method for creating a dynamic occupancy grid map according to an embodiment of the disclosure; and

FIG. 9 is a view more specifically illustrating step S830 according to an embodiment.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

For general radar sensors, there are various reasons why the observed point clouds may not be dense even though a target is positioned in a short distance.

The above-described causes may include when a range-Doppler (RD) map created in a high radar cross section (RCS) environment, such as when the target spans a side lobe area with a relatively weak signal strength or a congested situation where it is in a tunnel or many vehicles are distributed, has a lot of noise, or when effective peak information is not detected by a peak detection logic such as a constant false alarm rate (CFAR) algorithm.

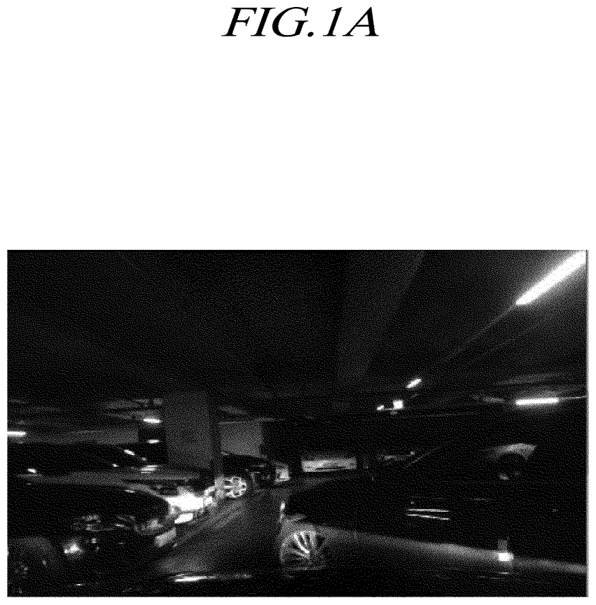

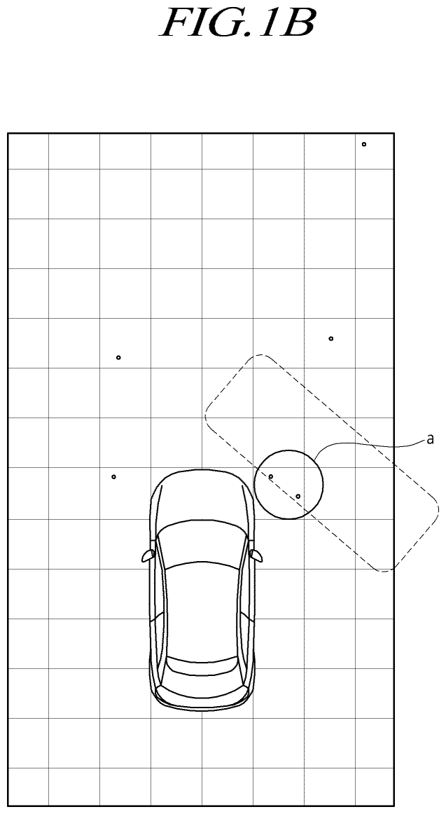

FIG. 1A is a view illustrating that a cut-in occurs as another vehicle enters from a rear right side of a host vehicle in a traveling direction according to an embodiment. FIG. 1B is a view illustrating a result of detection of a radar sensor equipped in a host vehicle in the situation of FIG. 1A according to an embodiment.

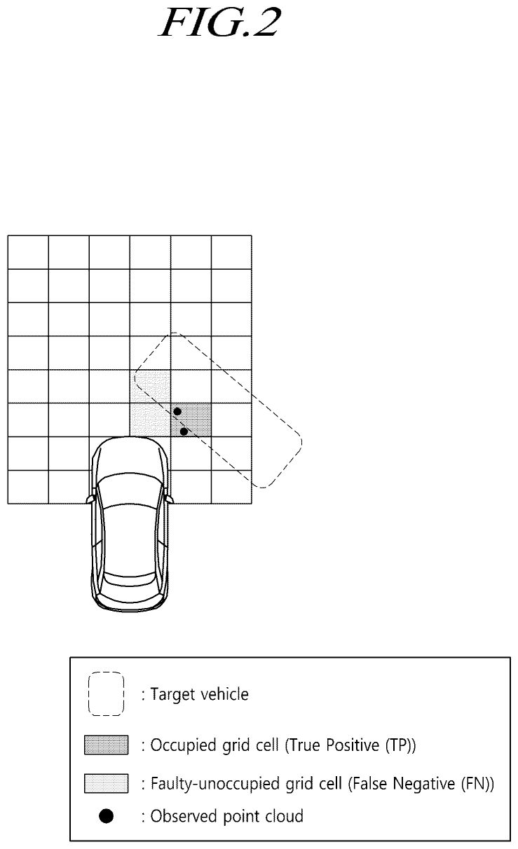

FIG. 2 is a view illustrating creating a dynamic occupancy grid map based on the result of FIG. 1B according to an embodiment.

Referring to FIGS. 1A and 1B, it may be identified that the number of point clouds detected in a of FIG. 1B indicates that the signal strength of another vehicle is relatively weak because the vehicle spans the side lobe area. In other words, the number of point clouds detected for another vehicle on the radar sensor may be limited.

Referring to FIG. 2, as the grid cell occupied according to insufficient cloud points on the dynamic occupancy grid map does not occupy the traveling path of the host vehicle, it may be determined that the other vehicle does not block the traveling path of the host vehicle on the map although it indeed blocks.

In this case, it may be difficult to provide an advance driver assistance systems (ADAS) function that utilizes radar information of the radar sensor due to misrecognition of the radar sensor.

To address the above-described issues, a reliable dynamic occupancy grid map creation device 10 is described which may overcome the harsh conditions of sparse measurements only with radar sensors.

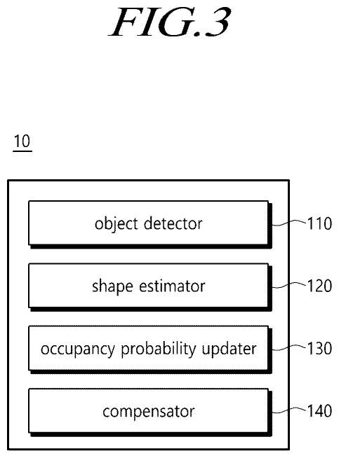

FIG. 3 is a block diagram schematically illustrating a dynamic occupancy grid map creation device 10 according to an embodiment of the disclosure.

Referring to FIG. 3, the dynamic occupancy grid map creation device 10 may include an object detector 110, a shape estimator 120, an occupancy probability updater 130, and a compensator 140.

Specifically, the dynamic occupancy grid map creation device 10 may calculate a measurement based on a reception signal received from a radar sensor and detect an object around a host vehicle, estimate a shape of a target vehicle when the target vehicle is detected from the measurement, ellipse-fit the shape of the target vehicle to a point cloud and update an occupancy probability of a grid for the target vehicle of a dynamic occupancy grid map (DOGM) based on the fitted shape, and compensate for a position of the host vehicle over time, on the dynamic occupancy grid map.

In an embodiment, the dynamic occupancy grid map creation device 10 may be an ADAS that provides information for assisting driving of a host vehicle or provides assistance for controlling the host vehicle.

The dynamic occupancy grid map creation device 10 according to the disclosure may be equipped in a manned vehicle which is controlled by the driver aboard or an autonomous vehicle.

The object detector 110 may calculate a measurement based on a reception signal received from a radar sensor and detect an object around the host vehicle.

Specifically, the object detector 110 may receive reception information from a plurality of radar sensors equipped in the host vehicle and, for example, may receive reception information from a front radar sensor detecting the front, a rear/side radar sensor detecting the rear/side, and various radar sensors detecting the sides and front/side.

In an embodiment, the radar sensor equipped in the host vehicle may include an antenna unit, a radar transmitter, a radar receiver, and the like.

Specifically, the antenna unit may include one or more transmission antennas and one or more reception antennas. Each transmission/reception antenna may be an array antenna including one or more radiation elements connected in series through feeding lines but is not limited thereto.

The antenna unit may include a plurality of transmission antennas and a plurality of reception antennas and may have various array structures depending on the arrayed order and arrayed interval.

The radar transmitter may function to switch to one of the plurality of transmission antennas included in the antenna unit to transmit a transmission signal through the switched transmission antenna or to transmit transmission signals through multiple transmission channels assigned to the plurality of transmission antennas.

The radar transmitter include an oscillation unit that generates transmission signals for one transmission channel allocated to the switched transmission antenna or multiple transmission channels allocated to the plurality of transmission antennas. The oscillator may include, e.g., a voltage-controlled oscillator (VCO) and an oscillator.

The radar receiver may receive a reception signal, which is reflected by the object, through the reception antenna.

The radar receiver may switch to one of the plurality of reception antennas and receive the reception signal, which is the transmission signal reflected by the target, through the switched reception antenna or receive the reception signal through multiple reception channels allocated to the plurality of reception antennas.

The radar receiver may include, e.g., a low noise amplifier (LNA) that low-noise amplifies the reception signal, which is received through one reception channel allocated to the switched reception antenna or through multiple reception channels allocated to the plurality of reception antennas, a mixer that mixes the low-noise amplified reception signal, an amplifier that amplifies the mixed reception signal, and an analog-digital converter (ADC) that converts the amplified reception signal into a digital signal to thereby generate reception data.

The object detector 110 may calculate a measurement by performing a fast Fourier transform (FFT) on the reception signal. Specifically, the producer 120 may convert the reception signal into the distance (range)-time index by performing primary FFT on the frequency and convert it into the range-velocity (Doppler) index by performing secondary FFT on the time.

The object detector 110 may detect the object around the host vehicle based on the position of calculation of each measurement and the relative velocity between each measurement and the host vehicle.

When the target vehicle is detected, the shape estimator 120 may estimate the shape of the target vehicle. The target vehicle may be set while the disclosure provides ADAS. For example, the target vehicle may be a vehicle that blocks the vehicle traveling path of host vehicle when performing ACC. The target vehicle may be determined according to a preset condition. In particular, it may be determined regardless of the front, side, and rear of the target vehicle. Further, the target vehicle may be set as a vehicle positioned or likely to be positioned on the path of the vehicle.

The shape estimator 120 may generate a track using a measurement to estimate the shape of the target vehicle. The shape estimator 120 may generate a track to include adjacent measurements, and the center of the track may be calculated as an average of the included measurements. The shape estimator 120 may detect the target vehicle by comparing the track generated in the previous scan with the track generated in the current scan.

In an embodiment, the shape estimator 120 may estimate the shape of the target vehicle using extended object tracking (EOT). Extended object tracking may refer to a tracking technique considering the shape of an object, such as the direction angle, width, and length in addition to a point target tracking technique for estimating the position and velocity of the object.

The shape estimator 120 may use one of a random matrix method (a method of estimating a random metric including the direction angle and major/minor axis information about an ellipse) and an explicit parameterization method (a method of estimating a random vector by explicitly modeling the direction angle and major/minor axis about an ellipse) among elliptical extended object tracking methods, and in some cases, may use a hybrid measurement equation by combining two or more methods into the form of an interacting multiple model (IMM).

The shape estimator 120 may estimate the shape of the target vehicle by applying extended object tracking to the detected target vehicle.

As described above, in the disclosure, information about a track having a predetermined size may be estimated by applying extended object tracking.

The occupancy probability updater 130 may ellipse-fit the shape of the target vehicle to the point cloud, and update the occupancy probability of the grid for the target vehicle of the dynamic occupancy grid map (DOGM) based on the fitted shape.

The point cloud may refer to a data set formed by gathering a plurality of measurements. For example, the point cloud may be a set of measurements clustered in the process of generating a track.

The occupancy probability updater 130 may fit the shape of the target vehicle into an ellipse. Ellipse fitting is a method used for computer vision and pattern recognition.

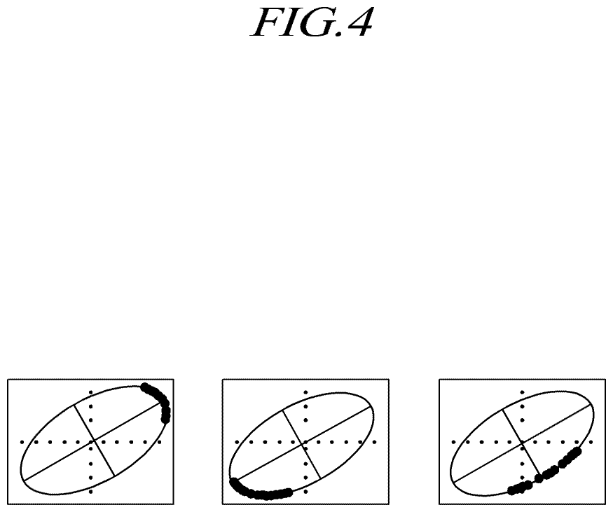

FIG. 4 is a view illustrating ellipse fitting by applying a least squares method according to an embodiment.

Referring to FIG. 4, the occupancy probability updater 130 may calculate the center of the ellipse based on a least squares method. The occupancy probability updater 130 may calculate the most suitable optimal ellipse by applying the least squares method to the point cloud detected in two dimensions.

The occupancy probability updater 130 may update the grid occupancy probability for the target vehicle only when a track of the target vehicle exists in the dynamic occupancy grid map.

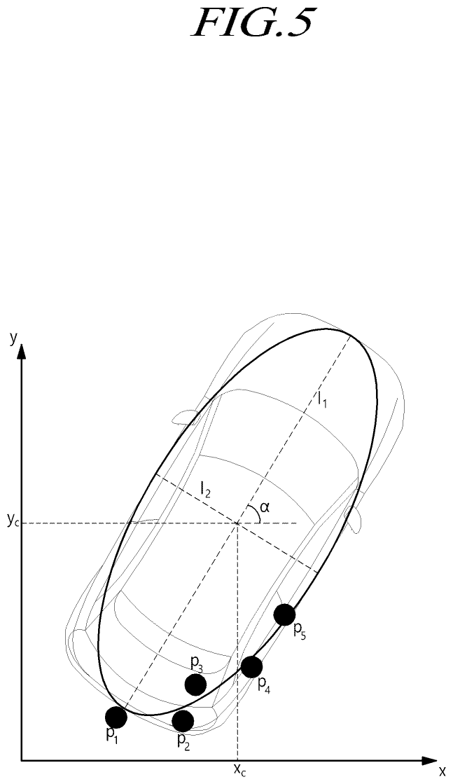

FIG. 5 is a view illustrating fitting a shape of a target vehicle to a track and a point cloud according to an embodiment.

Referring to FIG. 5, the occupancy probability updater 130 may fit the shape of the target vehicle to the point clouds p₁, p₂, p₃, p₄, and p₅ used for track update. For example, the occupancy probability updater 130 may fit the shape of the target vehicle to form a closest ellipse for the plurality of point clouds.

The occupancy probability updater 130 may perform ellipse fitting using Equation 1 below.

$${Ax}^{2} + Bxy + {Cy}^{2} + Dx + Ey + F = 0 \qquad [ Equation 1 ]$$

$$where$$

$$A = {l}_{2}^{2} {cos}^{2} ( θ ) + {l}_{1}^{2} {sin}^{2} ( θ )$$

$$B = ( {l}_{2}^{2} - {l}_{1}^{2} ) sin ( 2 θ )$$

$$C = {l}_{2}^{2} {sin}^{2} ( θ ) + {l}_{1}^{2} {cos}^{2} ( θ )$$

$$D = - ( 2 {Ax}_{c} + {By}_{c} )$$

$$E = - ( 2 {Cy}_{c} + {Bx}_{c} )$$

$$F = {Ax}_{c}^{2} + {Cy}_{c}^{2} + {Bx}_{c} {y}_{c} - {l}_{1}^{2} {l}_{2}^{2}$$

Here, x_{c}, y_{c} are the center position of the ellipse, l₁ and l₂ are the major and minor axes of the fitted ellipse, and θ may mean the angle between the x-axis and the major axes (α in FIG. 5). The occupancy probability updater 130 may calculate the center position of the ellipse using the least squares method to fit the optimal ellipse to the point cloud. Further, the occupancy probability updater 130 may fit the center position of the track to the point cloud as the center (x_{c}, y_{c}) of the ellipse.

As described above, the disclosure may estimate a more accurate shape of the target vehicle by performing ellipse fitting based on the detected point cloud or track.

In the disclosure, the position of the ellipse calculated according to Equation 1 described above may be used only when updating the dynamic occupancy grid map but may not be reflected in elliptical extended object tracking for estimating the shape of the target vehicle. Accordingly, the disclosure may guarantee that the expected performance in Bayesian filtering may be maintained and the shape of the target object may be accurately estimated because there is a risk that the filter may diverge when the estimate is forcibly corrected.

In an embodiment, the occupancy probability updater 130 may perform fitting so that the center of the ellipse is positioned within a predetermined distance from the center of the target vehicle updated at the previous time. Accordingly, the disclosure may prevent the result of the least squares method from being overfitted in an unintended direction when a small number of points are detected.

The occupancy probability updater 130 may predict an occupancy probability over time. The occupancy probability updater 130 may predict the movement of the moving object and update the occupancy probability based on the updated occupancy probability of the grid. In an embodiment, the occupancy probability updater 130 may input the updated occupancy probability of the grid to a prediction model to which the Kalman filter, the extended Kalman filter, the unscented Kalman filter, the recurrent neural networks (RNN), and the convolutional neural networks (CNN) are applied, obtaining the occupancy probability over time as output data.

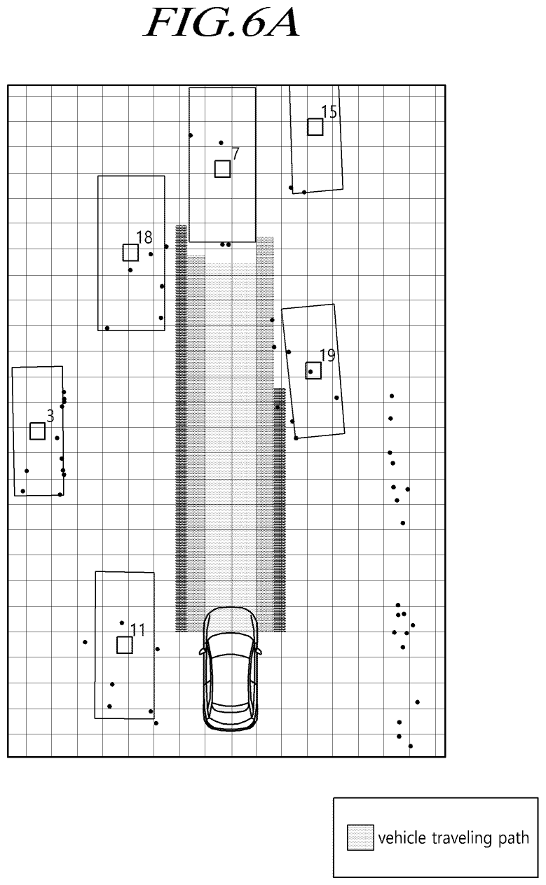

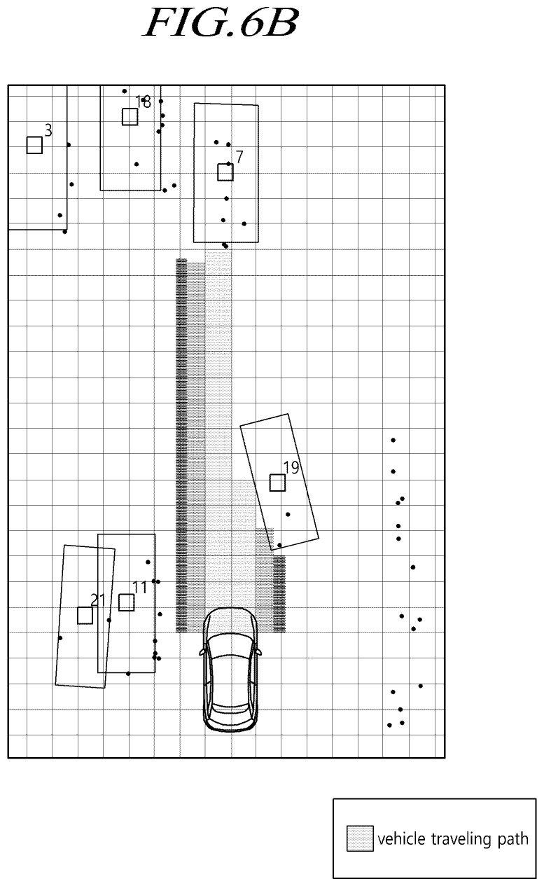

FIG. 6A is a view illustrating a situation before a target vehicle cuts in a vehicle traveling path of a host vehicle, on a dynamic occupancy grid map according to an embodiment. FIG. 6B is a view illustrating a situation when a target vehicle cuts in a vehicle traveling path of a host vehicle, on a dynamic occupancy grid map according to an embodiment.

Referring to FIGS. 6A and 6B, a target vehicle (track 19) is before cutting in to the vehicle traveling path of the host vehicle in FIG. 6A, and is after cutting into the vehicle traveling path in FIG. 6B.

If the general dynamic occupancy grid map is updated, since the point cloud is not detected on the vehicle progress path in FIG. 6B, the host vehicle may misjudge as a free space up to the preceding vehicle (track 7), failing to respond accordingly.

In contrast, the situation of updating the dynamic occupancy grid map according to the disclosure may determine that the target vehicle blocks the vehicle traveling path of the host vehicle by estimating the shape of the target vehicle and ellipse-fitting the same by extended object tracking although the point cloud is not detected on the vehicle traveling path as shown in FIG. 6B and accordingly respond (host vehicle deceleration control in the case of ACC operation).

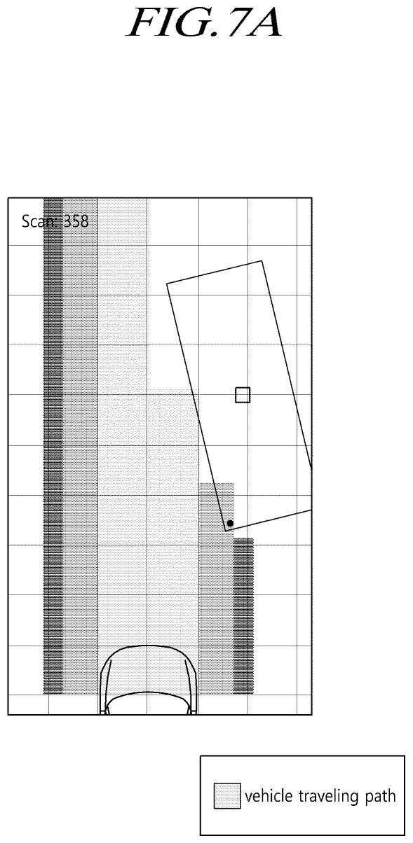

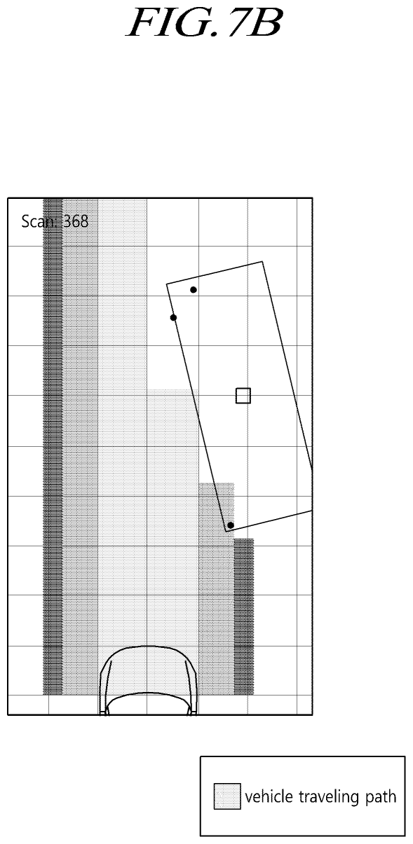

FIG. 7A is a view illustrating a time when a target vehicle cuts in a vehicle traveling path of a host vehicle, on a dynamic occupancy grid map according to an embodiment. FIG. 7B is a view illustrating a time when a point cloud is detected in a vehicle traveling path of a host vehicle on a dynamic occupancy grid map according to an embodiment.

Referring to FIGS. 7A and 7B, in the general dynamic occupancy grid map update, a situation where the target vehicle cuts in in the 358th scan occurs, and no point cloud is detected on the vehicle traveling path up to the 368th scan, so that the ADAS function such as ACC may malfunction

In contrast, according to the disclosure, in the 358th scan, the shape of the target vehicle may be estimated based on the track or the point cloud of the target vehicle, and the occupancy probability may be updated so that the cut-in of the target vehicle may be recognized.

The compensator 140 may compensate for the position of the host vehicle over time on the dynamic occupancy grid map.

In the compensator 140, the reception signal may be continuously received while the vehicle moves, and the position of the vehicle before the update and the position of the vehicle after the update may be different from each other on the dynamic occupancy grid map. Accordingly, the compensator 140 may correct the position of the host vehicle to the time when the reception signal is received and consistently express all data on the dynamic occupancy grid map at the same reference time.

According to an embodiment, the dynamic occupancy grid map creation device 10 may be implemented as an electronic control unit (ECU). The ECU may include at least one or more of one or more processors, a memory, a storage unit, a user interface input unit, or a user interface output unit which may communicate with one another via a bus. The computer system may also include a network interface for accessing a network. The processor may be a central processing unit (CPU) or semiconductor device that executes processing instructions stored in the memory and/or the storage unit. The memory and the storage unit may include various types of volatile/non-volatile storage media. For example, the memory may include a read only memory (ROM) and a random access memory (RAM).

Described below is a motor control method using the dynamic occupancy grid map creation device 10 capable of performing the above-described embodiments of the disclosure.

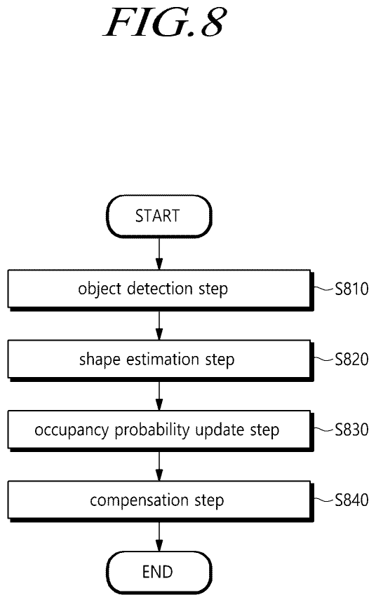

FIG. 8 is a flowchart illustrating a method for creating a dynamic occupancy grid map according to an embodiment of the disclosure.

Referring to FIG. 8, a dynamic occupancy grid map creation device according to the disclosure may include an object detection step S810 calculating a measurement based on a reception signal received from a radar sensor and detecting an object around a host vehicle, a shape estimation step S820 estimating a shape of a target vehicle when the target vehicle is detected, an occupancy probability update step S830 ellipse-fitting the shape of the target vehicle to a point cloud and updating an occupancy probability of a grid for the target vehicle of a dynamic occupancy grid map (DOGM) based on the fitted shape, and a compensation step S840 compensating for a position of the host vehicle over time, on the dynamic occupancy grid map.

The shape estimation step S820 may estimate the shape of the target vehicle using extended object tracking (EOT). The dynamic occupancy grid map creation method according to the disclosure may initialize the dynamic occupancy grid map before performing shape estimation.

The occupancy probability update step S830 may update the grid occupancy probability for the target vehicle only when a track of the target vehicle exists in the dynamic occupancy grid map.

The occupancy probability update step S830 may fit the shape of the target vehicle to the point cloud used to update the track.

The occupancy probability update step S830 may fit the center position of the track to the point cloud as the center of the ellipse.

The occupancy probability update step S830 may perform fitting so that the center of the ellipse is positioned within a predetermined distance from the center of the target vehicle updated at the previous time. Here, the center of the target vehicle may mean the center position of the ellipse fitted to the point cloud detected in the previous scan.

The occupancy probability update step S830 may calculate the center of the ellipse based on the least squares method.

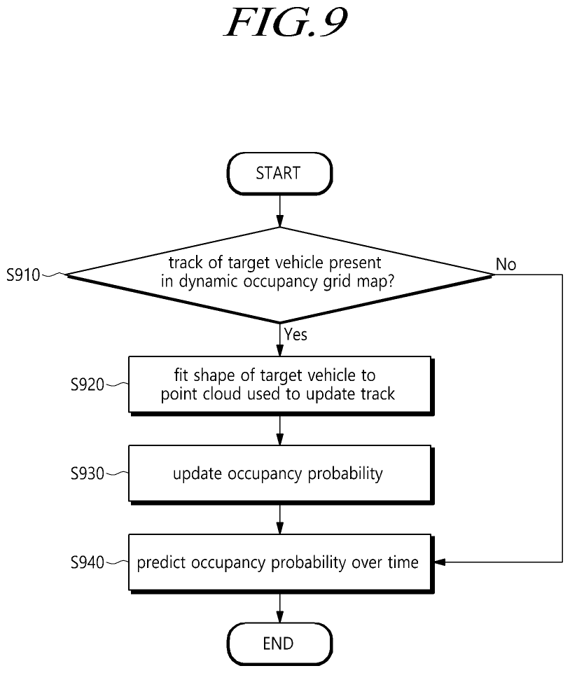

FIG. 9 is a view more specifically illustrating step S830 according to an embodiment.

Referring to FIG. 9, the dynamic occupancy grid map creation device 10 may determine whether a track of a target vehicle is present in the dynamic occupancy grid map (S910).

When the track of the target vehicle is present in the dynamic occupancy grid map (Yes in S910), the dynamic occupancy grid map creation device 10 may ellipse-fit the shape of the target vehicle to the point cloud used to update the track (S920).

The dynamic occupancy grid map creation device 10 may update the occupancy probability of the corresponding grid in the dynamic occupancy grid map using the ellipse-fitted shape (S930).

The dynamic occupancy grid map creation device 10 may predict the moving direction of updated moving objects and predict the occupancy probability of the grid correspond thereto (S940).

As described above, according to the disclosure, the dynamic occupancy grid map creation device and method may create an accurate and robust dynamic occupancy grid map even in harsh conditions where the radar sensor has difficulty in sensing, only with radar sensors, thereby enhancing recognition performance.

Further, the disclosure may more accurately estimate the shape of the target vehicle merely with a small number of point clouds, thereby providing a robust ADAS function.

Further, the disclosure updates the occupancy probability of the grid using a track and may thus create an effective dynamic occupancy grid map even in an environment where many clusters, such as ground signals or upper structures, are detected.

Meanwhile, the dynamic occupancy grid map creation device and/or method according to the disclosure may be implemented by a vehicle control device.

For example, the vehicle control device may include at least one memory including a computer program instruction and at least one processor executing the computer program instruction. The vehicle control device may be an electronic control device including a semiconductor device, such as an ECU or an MCU.

Here, the at least one processor may calculate a measurement based on a reception signal received from a radar sensor and detect an object around a host vehicle, estimate a shape of a target vehicle when the target vehicle is detected, ellipse-fit the shape of the target vehicle to a point cloud and update an occupancy probability of a grid for the target vehicle of a dynamic occupancy grid map (DOGM) based on the fitted shape. Further, the at least one processor may compensate for the position of the host vehicle over time on the dynamic occupancy grid map and apply the same.

Further, the at least one processor may update the grid occupancy probability for the target vehicle only when a track of the target vehicle exists in the dynamic occupancy grid map.

For example, the at least one processor may fit the shape of the target vehicle to the point cloud used to update the track.

As another example, the at least one processor may fit the center position of the track to the point cloud as the center of the ellipse.

Meanwhile, the at least one processor may perform fitting so that the center of the ellipse is positioned within a predetermined distance from the center of the target vehicle updated at the previous time.

Further, the at least one processor may estimate the shape of the target vehicle using extended object tracking (EOT).

Further, the vehicle control device may perform the operations of the above-described dynamic occupancy grid map creation device and/or method.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims.

The scope of the disclosure should be construed by the following claims, and all technical spirits within equivalents thereof should be interpreted to belong to the scope of the disclosure.

What is claimed is:

1. A dynamic occupancy grid map creation device, comprising:
an object detector calculating a measurement based on a reception signal received from a radar sensor and detecting an object around a host vehicle;
a shape estimator estimating a shape of a target vehicle when the target vehicle is detected;
an occupancy probability updater ellipse-fitting the shape of the target vehicle to a point cloud and updating an occupancy probability of a grid for the target vehicle of a dynamic occupancy grid map (DOGM) based on the fitted shape; and
a compensator compensating for a position of the host vehicle over time, on the dynamic occupancy grid map.

2. The dynamic occupancy grid map creation device of claim 1, wherein the occupancy probability updater updates the occupancy probability of the grid for the target vehicle only when a track of the target vehicle is present in the dynamic occupancy grid map.

3. The dynamic occupancy grid map creation device of claim 2, wherein the occupancy probability updater fits the shape of the target vehicle to a point cloud used to update the track.

4. The dynamic occupancy grid map creation device of claim 2, wherein the occupancy probability updater fits a center position of the track to the point cloud around the ellipse.

5. The dynamic occupancy grid map creation device of claim 1, wherein the occupancy probability updater fits a center of the ellipse to be positioned within a predetermined distance from a center of the target vehicle updated at a previous time.

6. The dynamic occupancy grid map creation device of claim 1, wherein the shape estimator estimates the shape of the target vehicle using extended object tracking (EOT).

7. The dynamic occupancy grid map creation device of claim 1, wherein the occupancy probability updater calculates a center of the ellipse based on a least squares method.

8. A dynamic occupancy grid map creation method, comprising:
calculating a measurement based on a reception signal received from a radar sensor and detecting an object around a host vehicle;
estimating a shape of a target vehicle when the target vehicle is detected;
ellipse-fitting the shape of the target vehicle to a point cloud and updating an occupancy probability of a grid for the target vehicle of a dynamic occupancy grid map (DOGM) based on the fitted shape; and
compensating for a position of the host vehicle over time, on the dynamic occupancy grid map.

9. The dynamic occupancy grid map creation method of claim 8, wherein updating the occupancy probability updates the occupancy probability of the grid for the target vehicle only when a track of the target vehicle is present in the dynamic occupancy grid map.

10. The dynamic occupancy grid map creation method of claim 9, wherein updating the occupancy probability fits the shape of the target vehicle to a point cloud used to update the track.

11. The dynamic occupancy grid map creation method of claim 9, wherein updating the occupancy probability fits a center position of the track to the point cloud around the ellipse.

12. The dynamic occupancy grid map creation method of claim 8, wherein updating the occupancy probability fits a center of the ellipse to be positioned within a predetermined distance from a center of the target vehicle updated at a previous time.

13. The dynamic occupancy grid map creation method of claim 8, wherein estimating the shape estimates the shape of the target vehicle using extended object tracking (EOT).

14. The dynamic occupancy grid map creation method of claim 8, wherein updating the occupancy probability calculates a center of the ellipse based on a least squares method.

15. A vehicle control device controlling a vehicle by creating a dynamic occupancy grid map, comprising:
at least one memory including a computer program instruction; and
at least one processor executing the computer program instruction, wherein the at least one processor:
calculates a measurement based on a reception signal received from a radar sensor and detects an object around a host vehicle;
estimates a shape of a target vehicle when the target vehicle is detected;
ellipse-fits the shape of the target vehicle to a point cloud and updating an occupancy probability of a grid for the target vehicle of a dynamic occupancy grid map (DOGM) based on the fitted shape; and
compensates for a position of the host vehicle over time, on the dynamic occupancy grid map.

16. The vehicle control device of claim 15, wherein the at least one processor updates the occupancy probability of the grid for the target vehicle only when a track of the target vehicle is present in the dynamic occupancy grid map.

17. The vehicle control device of claim 16, wherein the at least one processor fits the shape of the target vehicle to a point cloud used to update the track.

18. The vehicle control device of claim 16, wherein the at least one processor fits a center position of the track to the point cloud around the ellipse.

19. The vehicle control device of claim 15, wherein the at least one processor fits a center of the ellipse to be positioned within a predetermined distance from a center of the target vehicle updated at a previous time.

20. The vehicle control device of claim 15, wherein the at least one processor estimates the shape of the target vehicle using extended object tracking (EOT).
